(19) United States
(12) Patent Application Publication
(10) Pub. No.: US 2008/0277323 A1
(43) Pub. Date: Nov. 13, 2008

(54) System for Sorting Objects, Such as Packages

(75) Inventor: Knud Stovring, Asperup (DK)

Correspondence Address: SEED INTELLECTUAL PROPERTY LAW GROUP PLLC, 701 FIFTH AVE, SUITE 5400, SEATTLE, WA, 98104, US

(73) Assignee: ANKER ANDERSEN A/S, Torring (DK)

(21) Appl. No.: 12/089,366

(22) PCT Filed: May 19, 2006
(86) PCT No.: PCT/DK2006/000273

§ 371 Date: Apr. 4, 2008

(30) Foreign Application Priority Data
Oct. 5, 2005 (DK) PA 2005 01395

(51) Int. Cl. B07C 5/12; B07C 5/02

(52) U.S. Cl. 209/576

(57) ABSTRACT

In a system for sorting packages (17), such as cans and bottles, the packages are transferred from a sack or the like to a tiltable unloading container (1), where the packages are supplied to a funnel (3) with an inclined conveyor belt (4) having a plurality of carriers (5, 6) between which the packages may be placed singly. The packages are moved from the funnel (3) up the inclined conveyor (4), and from there to a horizontal conveyor (11, 13) having five sections (8, 9, 10, 11, 12), it being possible to adjust the speed of some of the sections. The packages are guided from the 3rd section of the horizontal conveyor into and through a recording unit (13) by a translatory movement, where a plurality of cameras (15, 16) record characteristics of the individual package for use in the sorting, recording, compaction and the like. The invention provides a system in which sorting of cans and bottles may take place at a greater speed than before.

The invention relates to a system for recording and sorting objects, such as packages, in which the packages are advanced on several conveyor belts to a recording unit, in which the package type is determined by means of a plurality of cameras, following which the packages are fed to a sorting system, a compactor or the like in dependence on the type.

Such a system is known from WO 03/086666 A1. In this known system, packages are fed singly and with the bottom of the packages first. As the packages are fed singly to the system, it is clear that the speed, at which the system operates, is limited to some extent. In addition, the recording takes place in the known system in that the packages are rotated in the recording unit, so that one or two cameras can read a bar code, a safety label or the external geometry of the package.

Accordingly, an object of the invention is to provide a system which is capable of receiving a large number of packages at a time and automatically arranging the packages, so that they may be fed singly to a recording unit at a great speed.

The object of the invention is achieved by a system and a method for recording and sorting objects, such as packages, in which the packages are advanced on several conveyor belts to a recording unit, in which the package type is determined by means of a plurality of cameras, following which the packages are fed to a sorting system, a compactor or the like in dependence on the type, which is characterized by comprising the following parts:

a) a section formed by a funnel which is equipped with an inclined conveyor belt whose speed may be adjusted, and which has a plurality of carriers, so that a plurality of packages are arranged between the carriers,
b) a conveyor belt which is divided into sections whose speeds may be adjusted individually.

Hereby, the packages will be subjected to a rapid rough sorting, as they will be arranged in the funnel singly between the carriers with the bottom front-most or rearmost and be conveyed by the conveyor belts to the recording unit at the greatest possible speed, since the speed of the various sections may be adjusted.

Expediently, the conveyor belt is divided into a 1st section, a 2nd section, a 3rd section, a 4th section and a 5th section, and, as stated in claim 3, the 4th section and the 5th section are disposed in the recording unit.

To ensure stable feeding of the packages to the recording unit, it is advantageous that the carriers are disposed vertically relative to the conveyor belt at the entry to the inclined conveyor belt, while they are positioned horizontally at the end of the inclined conveyor belt, and are returned at the transition to the 1st section through holes and below the 1st section.

An expedient way of feeding packages to the funnel is that at least one tiltable unloading container is arranged in front of the funnel or is connected with a conveyor belt, said packages being supplied from a container or a sack.

If more than one unloading container is provided, the process proceeds even more rapidly, since the one unloading container may be filled, while the other unloading container is tilted upwards and is being emptied.

To control the speed of the inclined conveyor belt, it is advantageous if a photocell is arranged just before the recording unit at the 4th section, said photocell being adapted to measure the filling degree at the entry to the 4th section.

To ensure that only packages placed correctly longitudinally of the conveyor belt are fed to the recording unit, it is an advantage that both sides of the 1st section, the 2nd section and the 3rd section are open, whereby packages disposed transversely to these sections will fall out.

To handle packages falling down from the 1st section, the 2nd section and the 3rd section, it is advantageous that a return conveyor is arranged longitudinally of and at the side of the conveyor belt, where packages which have fallen out of the horizontal conveyor belt may be returned to the funnel.

To ensure rapid recording in the recording unit, it is expedient that the packages are advanced through the recording unit by a translatory movement with the bottom turned forwards or rearwards, as the recording may then take place without unnecessary fault messages be-cause of a wrong direction of the packages.

In order to keep the system in operation safely and continuously, it is advantageous that several unloading containers are used in the system, which may alternately be coupled to the funnel, e.g. by a rotary movement, or that the unloading container is providing with a grating whose mesh size is smaller than the size of the smallest package which is to be handled, or that the unloading container is equipped with a vibrator device.

In this manner, there will always be packages ready to be fed into the system, and all small pieces of broken glass, which are not desired in the system, will be passed through the grating under the action of the vibrator.

It may be a further characteristic of the invention that the 4th section and the 5th section are provided inside the recording unit, there being a gap between the 5th section and the 6th section.

In this manner, cameras may be positioned on a circle, which means that a bar code, safety label, etc. may be read very rapidly, without it being necessary to rotate the packages,

The invention will now be explained more fully with reference to the drawing, in which

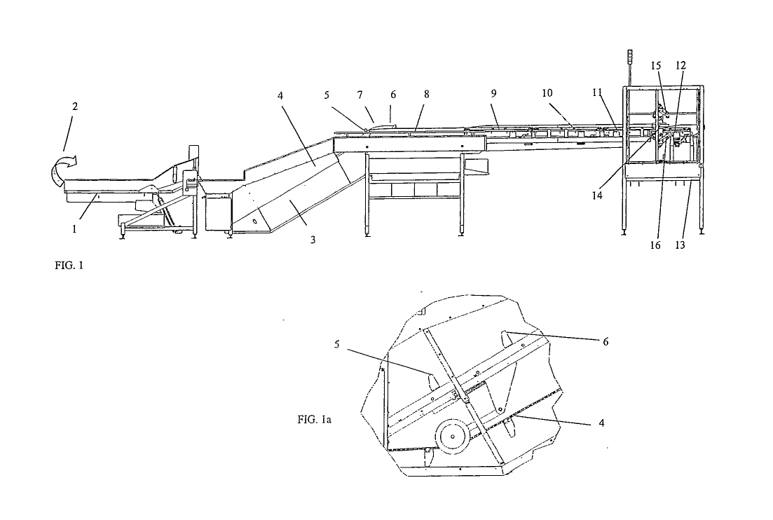

FIG. 1 shows the basic structure of a system according to an embodiment of the invention,

FIG. 1a shows a section of FIG. 1 on an enlarged scale,

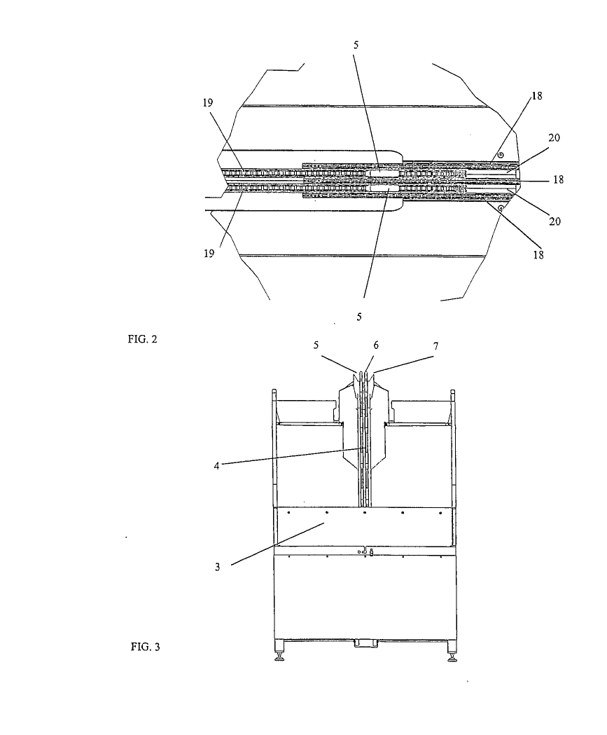

FIG. 2 shows the transition between an inclined conveyor belt and a horizontal conveyor belt, seen from above,

FIG. 3 shows a funnel incorporated in the system,

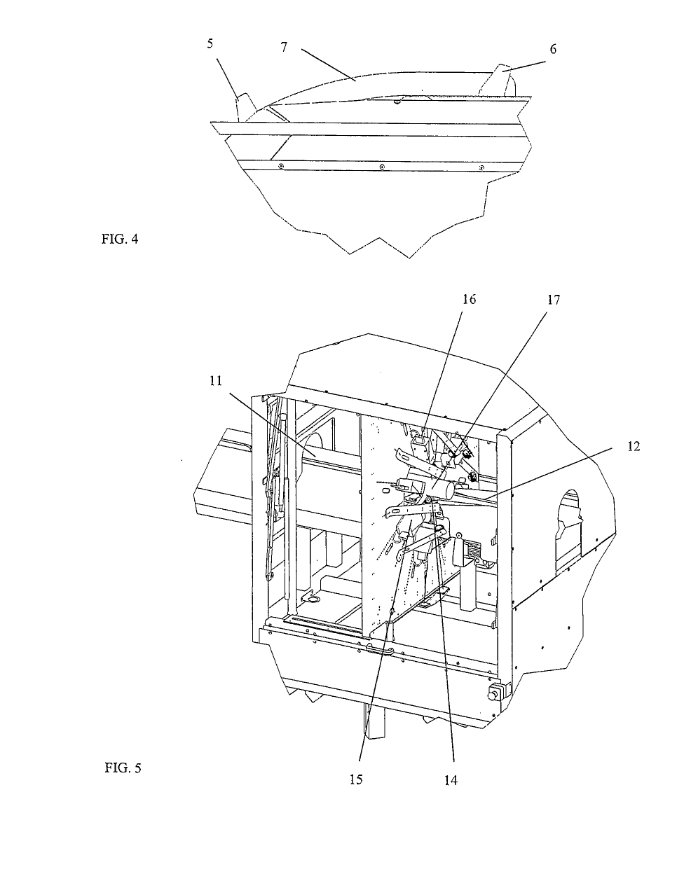

FIG. 4 shows parts of conveyor belts incorporated in the system, seen from the side, while

FIG. 5 shows a recording unit used in the system, seen in perspective.

In the figures, the numeral 1 designates an unloading container which may be tilted in the direction of the arrow 2, so that, after packages, such as bottles, cans and plastics packages, in various sizes have been filled in the container, it is tilted in the direction of the arrow 2, so that the packages are transferred to a funnel 3.

The packages may e.g. be stored in plastics sacks having a volume of a varying size. Each plastics sack may be provided with a label containing information on the origin of the plastics sack, so that a deposit may later be paid back to the person who has submitted the plastics sack for recording and sorting in the system.

Further, the unloading container is provided with a grating (not shown), which has a mesh size that is smaller than the smallest package which the system is to handle. Thus, the grating only allows small objects to pass the grating, which may be pieces of broken glass, loose caps or other small foreign bodies.

Before the unloading container is tipped, an operator will check whether large, undesired objects have been placed in the unloading container, and, if so, remove them.

Finally, the unloading container may be connected with a vibrator which vibrates the unloading container at a low frequency, e.g. 1-10 Hz. This vibration will contribute to making small objects pass the grating.

When the unloading container is then tipped, the packages are transferred to the funnel 3.

An inclined conveyor belt 4 defined on each side by a wall 7, cf. also FIG. 4, is arranged in the bottom of the funnel 3. The inclined conveyor belt 4 is provided with a plurality of carriers 5, 6. The distance between the carriers is greater than the length of the largest package which the system is to handle. Further, the carriers may be configured as pairs of carriers which are disposed side by side, as shown in FIG. 2.

As will additionally be seen in FIG. 2, the carriers are arranged on chains 19 which are driven around the inclined conveyor belt by rollers 18. When reaching the end of the inclined conveyor belt, the carriers 5, 6, together with the chains 19, will pass through holes 20 between the rollers 17.

When the inclined conveyor belt 4 runs, a plurality of packages will be placed between the carriers 5, 6 and be advanced with their bottom foremost or rearmost up the inclined conveyor belt toward a horizontal conveyor belt, which is divided into a 1st section 8, a 2nd section 9, a 3rd section 10, a 4th section 11 and a 5th section 12.

As will be seen, there is no wall along the horizontal conveyor belt, so that packages may fall out on both sides. The packages falling out may fall down on a return conveyor (not shown), which returns the packages to the funnel 3.

When the packages reach the top of the inclined conveyor belt 4, they continue along the five sections of the horizontal conveyor belt.

As will be seen, the 1st section 8, the 2nd section 9 and the 3rd section 10 are not provided with walls, and packages which are not disposed correctly longitudinally of the conveyor may therefore fall over the side edge and down on return conveyors (not shown) which are connected with the funnel 3.

The 2nd section 9 is caused to run at a constant speed corresponding to the maximum speed at which a subsequent recording unit 13 can handle packages. The speed of the subsequent 3rd section 10 may be slightly faster than the speed of the 2nd section 9, so that a greater distance between the packages may be provided inside the recording unit 13.

Further, the speed of the inclined conveyor belt may be adjusted so that packages are always transferred to the horizontal conveyor belt at such a speed that the 3rd section is always filled up.

In a practical embodiment, a photocell may be arranged at the end of the 1st section, said photocell recording how great the distance is between the arriving packages from the inclined conveyor belt, and in the event that this distance increases, the speed of the inclined conveyor belt may be increased.

The 4th section 11 and the 5th section 12 are provided inside the recording unit 13. As will be seen, there is a gap 14 between the 4th section and the 5th section. This gap allows cameras to be disposed inside the recording unit, which are arranged on a circle having a centre on the longitudinal axis of the packages. The figure shows two cameras 15, 16 which read data on a package 17 disposed in the gap 14. Of course, nothing prevents the use of more cameras.

Rotation of the package is hereby avoided, which means that the handling time in the recording unit may be reduced considerably.

1. A system for recording and sorting objects, such as packages (17), in which the packages are advanced on several conveyor belts (4, 8, 9, 10, 11, 12) to a recording unit (13), in which the package type is determined by means of a plurality of cameras (15, 16), following which the packages are fed to a sorting system, a compactor or the like in dependence on the type, characterized by comprising the following parts:
a) a section formed by a funnel (3), which is equipped with an inclined conveyor belt (4) whose speed may be adjusted, and which has a plurality of carriers (5, 6), so that a plurality of packages are arranged between (7) the carriers,
b) a conveyor belt which is divided into several sections (8, 9, 10, 11, 12) whose speeds may be adjusted individually.

2. A system of claim 1, wherein the conveyor belt is divided into a 1st section (8), a 2nd section (9), a 3rd section (10), a 4th section (11) and a 5th section (12).

3. A system of claim 2, wherein the 4th section (11) and the 5th section (12) are disposed in the recording unit (13).

4. A system of claim 1, wherein, at the entry to the inclined conveyor belt (4), the carriers (5, 6) are disposed vertically relative to the conveyor belt, while they are positioned horizontally at the end of the inclined conveyor belt (4), and are returned at the transition to the 1st section (8) through holes (20) and below the 1st section (8).

5. A system of claim 1, wherein at least one tiltable unloading container (1) is arranged in front of the funnel (3) or is connected with a conveyor belt, said packages being supplied from a container or a sack.

6. A system of claim 1, wherein a photocell is arranged just before the recording unit (13) at the 4th section (11), said photocell being adapted to measure the filling degree at the entry to the 4th section (11).

7. A system of claim 1, wherein both sides of the 1st section (8), the 2nd section (9) and the 3rd section (10) are open.

8. A system of claim 1, wherein a return conveyor is arranged longitudinally of and at the side of the conveyor belt, where packages (17) which have fallen out of the horizontal conveyor belt may be returned to the funnel (3).

9. A system of claim 1, wherein the packages (17) are advanced through the recording unit (13) by a translatory movement with the bottom turned forwards or rearwards.

10. A system of claim 1, wherein several unloading containers (1) are used in the system, which may alternately be connected with the funnel, e.g. by a rotary movement.

11. A system of claim 1, wherein the unloading container (1) is provided with a grating whose mesh size is smaller than the size of the smallest package which is to be handled.

12. A system of claim 1, wherein the unloading container is equipped with a vibrator device.

13. A system of claim 1, wherein the 4th section (11) and the 5th section (12) are provided inside the recording unit (13), there being a gap (14) between the 5th section and the 6th section.

14. A method of recording and sorting objects, such as packages by advancing the packages on conveyor belts to a recording unit and determining the package type in the recording unit comprising a plurality of cameras following which the packages are fed to a sorting system, a compactor or the like in dependence on the type, whereby said method further comprises the steps of:
receiving a plurality of packages in a section with a funnel and arranging the packages between a plurality of carriers which are provided on an inclined conveyor belt in this section and
advancing the packages from the inclined conveyor belt to a conveyor which is diverted into several section and wherein the conveyor speed of the sections may be individually adjusted.

15. A method of claim 14, wherein the conveyor belt is diverted into a first section (8), a second section (9), a third section (10), a fourth section (11) and a fifth section (12).

16. A method of claim 15, whereby the recording is provided in the 4th section (11) and the 5th section (12).

17. A method of claim 14, whereby at the entry to the inclined conveyor belt (4), the carriers (5, 6) are disposed vertically relative to the conveyor belt, while they are positioned horizontally at the end of the inclined conveyor belt (4), and are returned at the transition to the 1st section (8) through holes (20) and below the 1st section (8).

18. A method of claim 14, whereby said packages being supplied from a container or a sack to at least one tiltable unloading container (1) is arranged in front of the funnel (3) or is connected with a conveyor belt.

19. A method of claim 14, whereby a photocell is measuring the filling degree at the entry to the 4th section (11) just before the recording unit (13) at the 4th section (11).

20. A method of claim 14, whereby both sides of the 1st section (8), the 2nd section (9) and the 3rd section (10) are open.

21. A method of claim 14, whereby packages (17), which have fallen out of the horizontal conveyor belt, may be returned to the funnel (3) by a return conveyor is arranged longitudinally of and at the side of the conveyor belt.

22. A method of claim 14, whereby the packages (17) are advanced through the recording unit (13) by a translatory movement with the bottom turned forwards or rearwards.

23. A method of claim 14, whereby several unloading containers (1) are used in the system, which may alternately be connected with the funnel, e.g. by a rotary movement.

24. A method of claim 18, whereby the unloading container is equipped with a vibrator device.

25. A method of claim 14, whereby the 4th section (11) and the 5th section (12) are provided inside the recording unit (13), and such that a gap (14) is provided between the 5th section and the 6th section.
